(19) United States
(12) Patent Application Publication
(10) Pub. No.: US 2014/0114993 A1
(43) Pub. Date: Apr. 24, 2014

(54) METHOD AND SYSTEM FOR MAINTAINING DATA IN A DATA STORAGE SYSTEM

(71) Applicant: YAHOO! INC., Sunnyvale, CA (US)

(72) Inventors: Wuheng Luo, Savoy, IL (US); Allie K. Watfa, Urbana, IL (US); Bo Liu, Champaign, IL (US)

(73) Assignee: YAHOO! INC., Sunnyvale, CA (US)

(21) Appl. No.: 13/657,143

(22) Filed: Oct. 22, 2012

(51) Int. Cl. G06F 17/30

(52) U.S. Cl. 707/756; 707/E17.005

(57) ABSTRACT

Method, system, and programs for generating, storing, and maintaining data in a data storage system. A data record in a first format is received, and converted into one or more converted data records in a second format. Each of the one or more converted data records comprises a markup attribute, a content attribute, and an identifier attribute used to locate the data record in the first format. And the one or more converted data records are stored in the data storage system.

### BACKGROUND

1. Technical Field

The present disclosure relates to methods, systems, and programming for generating, storing, and maintaining data in a data storage system.

2. Discussion of Technical Background

Big data, especially data in Extensible Markup Language (XML) format, has long been a challenge to different data storage systems, relational or distributed. The challenge, is not only in terms of storage and extraction, but also in terms of analytics. For example, Hadoop is a distributed data system suffering weakness in ad hoc analytics for big data, especially big XML data.

To maintain XML data in a relational database management system (RDBMS), many approaches implemented or proposed involve certain mapping and conversion between XML elements and relational table columns. The lack of a common standard among major vendors of RDBMS makes those approaches specific system-dependent and not portable. Also, the mapping usually involves a tightly coupled one-to-one relationship between specific schemas and tables. Regarding distributed storage, difficulties with XML data are multi-fold for systems such as Hadoop. First, processing XML data is not straightforward. Hadoop application programming interface (API) does not provide an input format reader for XML. So developers have to either use some third-patty library/tool such as Avro or Mahout, or write their own interfaces. Second, it is very hard for Hadoop file system (HDFS) to make semantically meaningful distribution of XML data among data nodes, due to its data split nature. Third, it is not possible to extract XML data distributed in Hadoop in an SQL-like fashion, without some extra layer such as Hive or HBase on top of HDFS.

There are some common practices in XML data processing on the Hadoop Grid. One approach is to have delimiter-separated values stored in Hadoop's native HDFS as rows or tuples. With respect to XML data, this means to get rid of all the open and close tags and keep the atomic values in between. This approach is not satisfactory because removal of XML tags is against the original purpose to use XML data format. And this raises an issue of poor data integrity. Another solution is to convert the XML format into relational table style format, and map XML elements into table columns. This approach requires a specific schema or table definition for each unique XML file. Once the requirement for the data model is changed, the schema has to be modified, the table has to be dropped and re-created, and the data has to be re-processed. This raises an issue of poor data scalability.

Therefore, there is a need to provide a solution for generating, storing and maintaining data, especially big XML data without causing the above issues.

### SUMMARY

The present disclosure relates to methods, systems, and programming for maintaining data in a data storage system.

In one example, a method, implemented on at least one machine having at least one processor, storage, and a communication platform connected to a network for maintaining data in a data storage system is provided. A data file including one or more elements is received. Each element of the data file is converted to one or more records. Each record has one or more types of data. Each record is assigned to a row of a table in the data storage system. The table has a plurality of rows and a plurality of columns comprising at least a markup column, a content column, and a uniform resource identifier (URI) column. All data assigned to a same column belong to a same type. The data in the table is maintained.

In another example, a system for maintaining data in a data storage system is presented, which includes a receiver, a converting unit, a mapping unit, and a processor. The receiver is configured to receive a data file including one or more elements. The converting unit is coupled to the receiver and configured to convert each element of the data file to one or more records. Each record has one or more types of data. The mapping unit is coupled to the converting unit and configured to assign each record to a row of a table in the data storage system. The table has a plurality of rows and a plurality of columns comprising at least a markup column, a content column, and a URI column. All data assigned to a same column belong to a same type. The processor is configured to maintain data in the table.

In still another example, a method, implemented on at least one machine having at least one processor, storage, and a communication platform connected to a network for storing data in a data storage system is provided. A data record in a first format is received and converted into one or more converted data records in a second format. Each of the one or more converted data records comprises a markup attribute, a content attribute, and an identifier attribute used to locate the data record in the first format. And the one or more converted data records are stored in the data storage system.

In yet another example, a method, implemented on at least one machine having at least one processor, storage, and a communication platform connected to a network for generating data is provided. A piece of information comprising one or more parts is received. The one or more parts are identified. And for each part of the piece of information, a data record is generated. Each data record comprises a markup attribute, a content attribute, and an identifier attribute used to locate the corresponding part in the piece of information.

Other concepts relate to software for maintaining data in a data storage system. A software product, in accord with this concept, includes at least one machine-readable non-transitory medium and information carried by the medium. The information carried by the medium may be executable program code data regarding parameters in association with a request or operational parameters, such as information related to a user, a request, or a social group, etc.

In one example, a machine readable and non-transitory medium having information recorded thereon for maintaining data in a data storage system is provided, wherein the information, when read by the machine, causes the machine to perform a series of steps. A data file including one or more elements is received. Each element of the data file is converted to one or more records. Each record has one or more types of data. Each record is assigned to a row of a table in the data storage system. The table has a plurality of rows and a plurality of columns comprising at least a markup column, a content column, and a URI column. All data assigned to a same column belong to a same type. The data in the table is maintained.

Additional advantages and novel features will be set forth in part in the description which follows, and in part will become apparent to those skilled in the art upon examination of the following and the accompanying drawings or may be learned by production or operation of the examples. The advantages of the present disclosures may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 shows tables illustrating data placement and modification, according to an embodiment of prior art;

FIG. 2 depicts a block diagram of a data storage system for maintaining data in the data storage system, according to an embodiment of the present disclosure;

FIG. 3 depicts a block diagram illustrating an example of a mapping unit, a storage unit, and a processor shown in FIG. 2, according to an embodiment of the present disclosure;

FIG. 4 is a flow chart illustrating an example of a method for maintaining data in a data storage system, according to an embodiment of the present disclosure;

FIG. 5 is a flow chart illustrating another example of a method for maintaining data in a data storage system, according to an embodiment of the present disclosure;

FIG. 6 is a flow chart illustrating an example of two steps in the method shown in FIG. 5, according to an embodiment of the present disclosure;

FIG. 7 shows a table illustrating an example of data placement, according to an embodiment of the present disclosure;

FIG. 8 shows tables illustrating an example of data modification, according to an embodiment of the present disclosure;

FIG. 9 shows tables illustrating another example of data modification, according to an embodiment of the present disclosure;

FIG. 10 shows an exemplary software definition, according to an embodiment of the present disclosure; and

FIG. 11 depicts a general computer architecture on which present disclosure can be implemented.

### DETAILED DESCRIPTION

In the following detailed description, numerous specific details are set forth by way of examples in order to provide a thorough understanding of the relevant disclosures. However, it should be apparent to those skilled in the art that the present disclosures may be practiced without such details. In other instances, well known methods, procedures, systems, components, and/or circuitry have been described at a relatively high-level, without detail, in order to avoid unnecessarily obscuring aspects of the present disclosures.

The present disclosure describes method, system, and programming aspects of maintaining data in a data storage system. The method and system as disclosed herein aim at easily maintaining data in a data storage system and especially big XML data in a column-oriented data warehouse, with ad hoc access and high scalability. Such method and system benefit data maintenance in several ways: for example, data from heterogeneous records in a table can be retrieved with a single query; data in the table can be modified vertically without changing quantity of columns in the table; one or more records satisfying same criteria based on their positions in the URI column can be retrieved with a single query; there is no need for special objects or data tree to store data; and there is no need for complicated algorithms or special query engines to retrieve data.

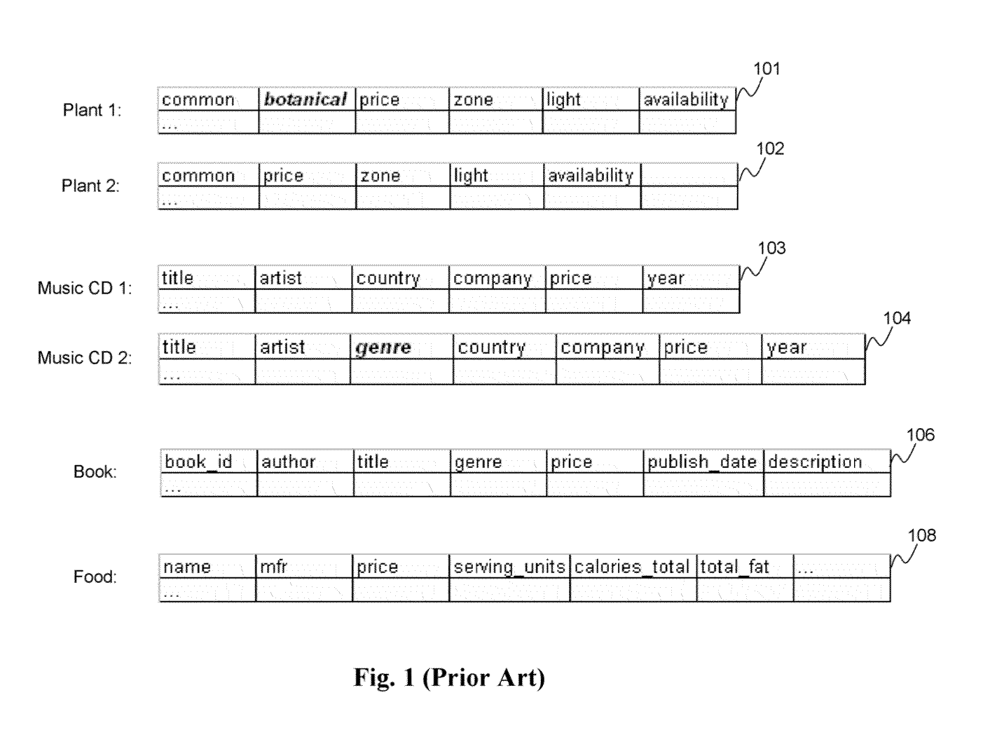

FIG. 1 shows tables illustrating data placement and modification, in accordance with an embodiment of prior art. In this example, there is purchase data for plant, music CD, book, and food, each in its own XML format. When converted into a platform like Hive, four different tables are needed due to heterogeneous contents of the data. To be specific, a sample of plant xml is converted to a plant table 101 with 6 columns; a sample of music CD.xml is converted to a music CD table 103 with 6 columns; a sample of book.xml is converted to a book table 106 with 7 columns; and a sample of food.xml is converted to a food table 108 with 16 columns (not all columns shown in 108). To query anything common to these four tables, one has to either issue four separate queries or join the four tables. Also, since the data model in this example is row-based, the table structure of each record needs to be altered each time when the requirement changes for the data model. Hence, to add or remove certain fields from a table, one has to change the structured data horizontally. For instance, removing the “botanical” column from the plant table 101 will change quantity of its fields from 6 to 5, as shown in table 102. And adding a “genre” column to the music CD table 103 will change quantity of its fields from 6 to 7, as shown in table 104. Depending on specific situations, there may be a need to do the following during these data modifications: modify the metadata definition; backup the stored data; drop the existing table; re-format the data old and new create a new table; and re-upload the data into the new table.

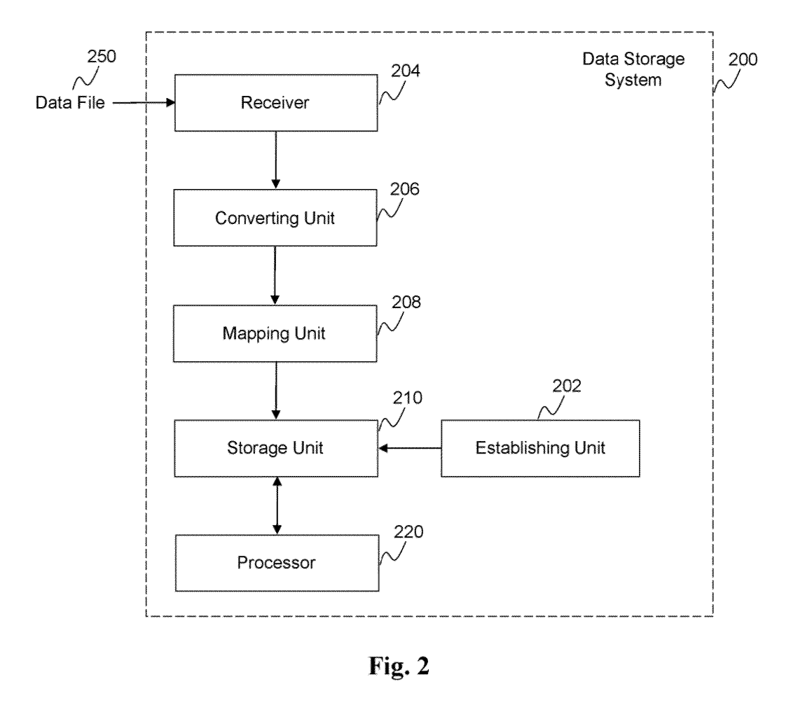

FIG. 2 depicts a block diagram of a data storage system for maintaining data in the data storage system, according to an embodiment of the present disclosure. In accordance with various examples of the embodiment, the data storage system 200 may be a database, a data warehouse, or a data file system. In FIG. 2, the data storage system 200 includes an establishing unit 202, a receiver 204, a converting unit 206, a mapping unit 203, a storage unit 210, and a processor 220. The receiver 204 is configured to receive a data file 250 including one or more elements. In one example, the data file 250 may have an XML format. The converting unit 206 is coupled to the receiver 204 and configured to convert each element of the data file 250 to one or more records. Each record has one or more types of data. The mapping unit 208 is coupled to the converting unit 206 and configured to assign each record to a row of a table in the data storage system 200. The table has a plurality of rows and a plurality of columns comprising at least a markup column, a content column, and a URI column. And all data assigned to a same column belong to a same type.

The establishing unit 202 is configured to establish the table in the data storage system 250 with a plurality of rows and a plurality of columns. In this example, the quantity of the columns is fixed. The storage unit 210 is coupled to the establishing unit 202 and the mapping unit 208, and configured to store the table. The processor 220 is coupled to the storage unit 210 and configured to maintain data in the table. In one example, the data storage system 200 may comprise a distributed data warehouse based on Hadoop or Hive. In others examples, each of the establishing unit 202, the receiver 204, the converting unit 206, the mapping unit 208, and the processor 220 may be located outside the data storage system 200.

Specifically, this example may involve maintaining big XML data in Hadoop ecosystem, using an open Hive schema. Although this open schema approach is applicable to RDBMS, native XML data storage system or column-oriented data store in general, this example focuses on solutions of analytics for big data warehouse in distributed environment. And hence Hive is chosen as the platform for the open schema. In this example, XML document to Hive table mapping is XML element-based and Hive table column-oriented. Each element of an XML file is converted into one or more Hive table rows, and the total number of columns are fixed.

In accordance with one exemplary embodiment, a method for storing data in a data storage system 200 is provided. A data record in a first format is received and converted into one or more converted data records in a second format. Each of the one or more converted data records comprises a markup attribute, a content attribute, and an identifier attribute used to locate the data record in the first format. And the one or more converted data records are stored in the data storage system 200. The one or more converted data records stored in the data storage system 200 may be maintained in some examples.

In accordance with another exemplary embodiment, a method for generating data is provided. A piece of information comprising one or more parts is received. The one or more parts are identified. And for each part of the piece of information, a data record is generated. Each data record comprises a markup attribute, a content attribute, and an identifier attribute used to locate the corresponding part in the piece of information. The generated one or more data records may be stored and maintained in a data storage system 200 in some examples.

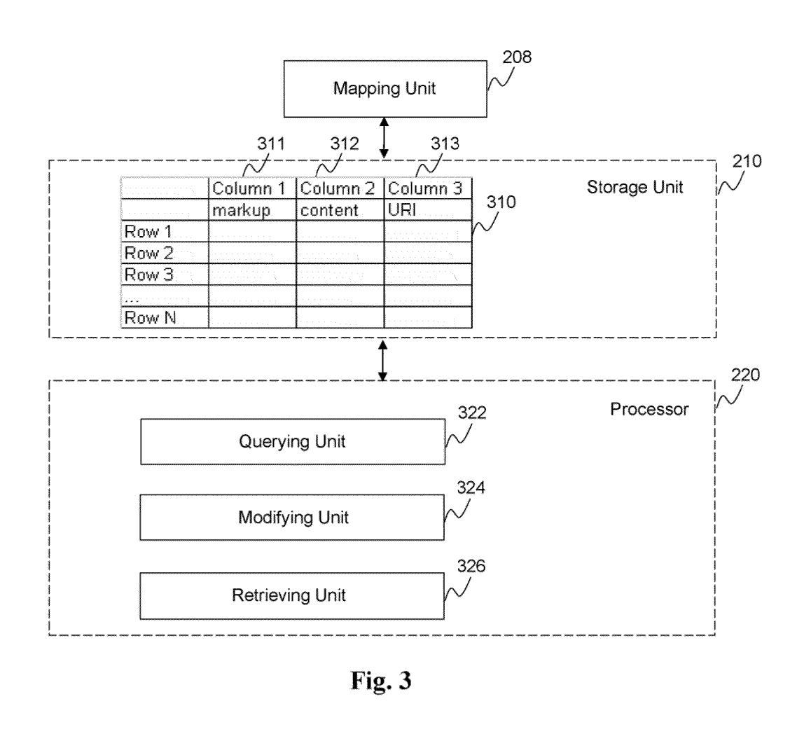

FIG. 3 depicts a block diagram illustrating an example of a mapping unit 208, a storage unit 210, and a processor 220 shown in FIG. 2, according to an embodiment of the present disclosure. In this example, a table 310 is stored in the storage unit 210 and includes a markup column 311, a content column 312, and a URI column 313. The table 310 also includes a plurality of rows each of which is assigned a record by the mapping unit 208. Each record in this example has at least three types of data: tag, value, and position. And for each record, the mapping unit 208 is configured to assign tag of the record to the markup column 311, assign value of the record to the content column 312, and assign position of the record to the URI column 313.

In one example, a set of generic Hive table columns may be defined. The markup column 311 may store tags if they have immediate atomic values. For tags without immediate atomic values, they are indicated in the URI column 313, not assigned to the markup column 311. For an element with multiple tags, the two tags are assigned to two rows of the markup column 311 respectively. The content column 312 is used to store atomic values of the markup tags. The URI column 313 stores a record's position in the XML document's hierarchical structure. In one example, the URI starts with a slash, “/”, to indicate the root; and each hierarchical level down the path is also separated by a “/”. For elements with multiple occurrences, “<sequence>” is used to indicate the order. For elements with single occurrence, “<sequence>” is also optionally used to indicate the order. For an element with multiple tags, “<sequence>” is optionally used to indicate the order. In one example, for an element like <img src=“madonna.jpg” alt=‘Foligno Madonna, by Raphael’/>, the two tags “src” and “alt” may be stored in two rows of the markup column 311, and “img:1” and “img:2” may be stored in the two rows of the URI column 313 respectively, to indicate their order. In another example, for multiple elements inside another element, “<element>.<sequence>.<sequence>” is optionally used in the URI column 313 to indicate the order.

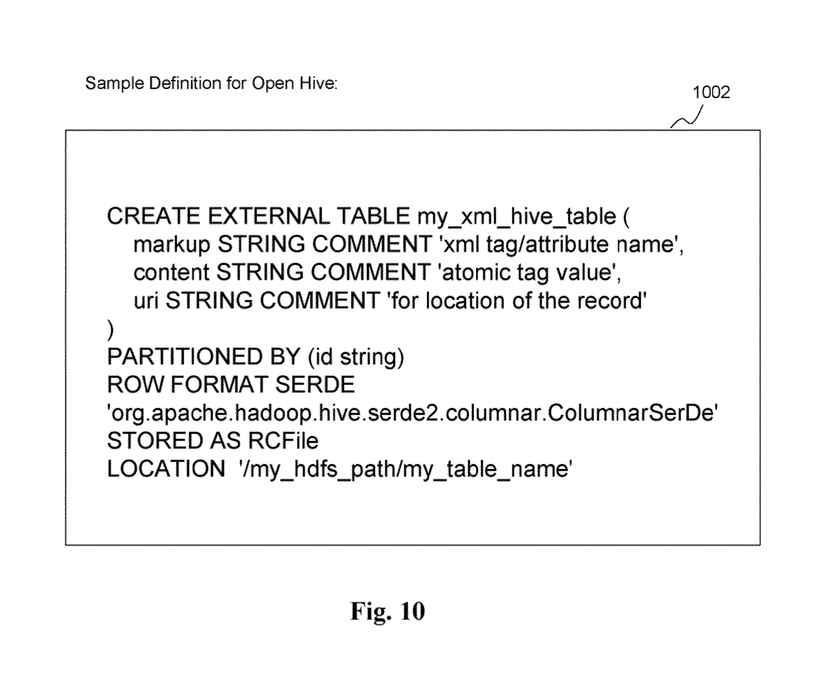

The open schema has an open data type, which is string by default. And the open schema approach supports various data types and data formats, including those compatible with Hive. FIG. 10 shows an exemplary software definition 1002 for the open Hive schema, according to an embodiment of the present disclosure.

In addition, the table 310 in this example may further comprise a virtual column identification (ID) used to query data by identifying a collection of records. A virtual column is a file system partition in the form of a file directory. In this example, the ID column is a partition key referring to a collection of XML elements, since analytical tasks are often collection based. Every record of the collection shares the same ID. Although the ID column is not physically within the table, it can be used for quick query. However, it cannot be used for any other data storage system operations, such as update or calculations. In another example, the ID column may be a physical column.

As shown in FIG. 3, the processor 220 in the example further comprises a querying unit 322, a modifying unit 324, and a retrieving unit 326. In one example, the querying unit 322 is configured to query data, with a single query, from heterogeneous records in the table 310 satisfying same criteria. In another example, the modifying unit 324 is configured to add one record to the table 310 by inserting one row to the table 310 without changing quantity of columns in the table 310. In still another example, the modifying unit 324 is configured to remove one record from the table 310 by deleting one row from the table 310 without changing quantity of columns in the table 310. In yet another example, the retrieving unit 326 is configured to retrieve, with a single query, one or more records in the table 310 satisfying same criteria based on their positions in the URI column.

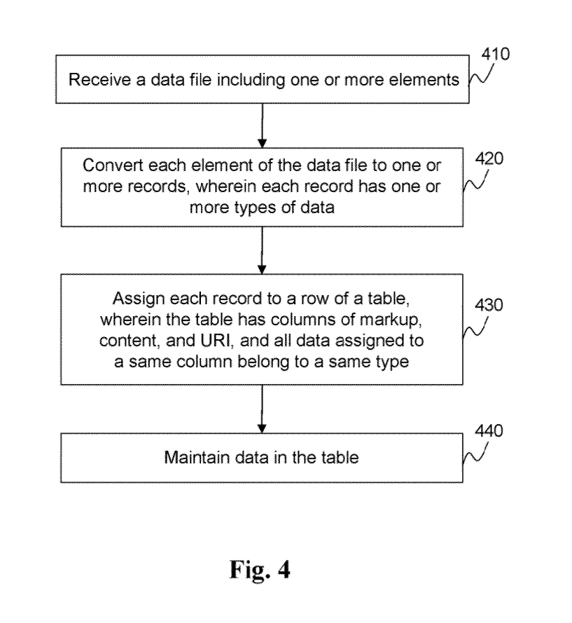

FIG. 4 is a flow chart illustrating an example of a method for maintaining data in a data storage system, according to an embodiment of the present disclosure. In accordance with various examples of the embodiment, the data storage system may be a database, a data warehouse, or a data file system. It will be described with reference to the above figures. However, any suitable unit may be employed. Beginning at block 410, a data file including one or more elements is received. As described above, this may be performed by the receiver 204. Proceeding to block 420, each element of the data file is converted to one or more records. And each record has one or more types of data. As described above, block 420 may be performed by the converting unit 206. Then at block 430, each record is assigned to a row of a table in the data storage system. The table has a plurality of rows and a plurality of columns comprising at least a markup column, a content column, and a uniform resource identifier (URI) column. And all data assigned to a same column belong to a same type. As described above, block 430 may be performed by the mapping unit 208 in conjunction with the storage unit 210. Moving to block 440, data in the table is maintained. As described above, block 440 may be performed by the processor 220 in conjunction with the storage unit 210.

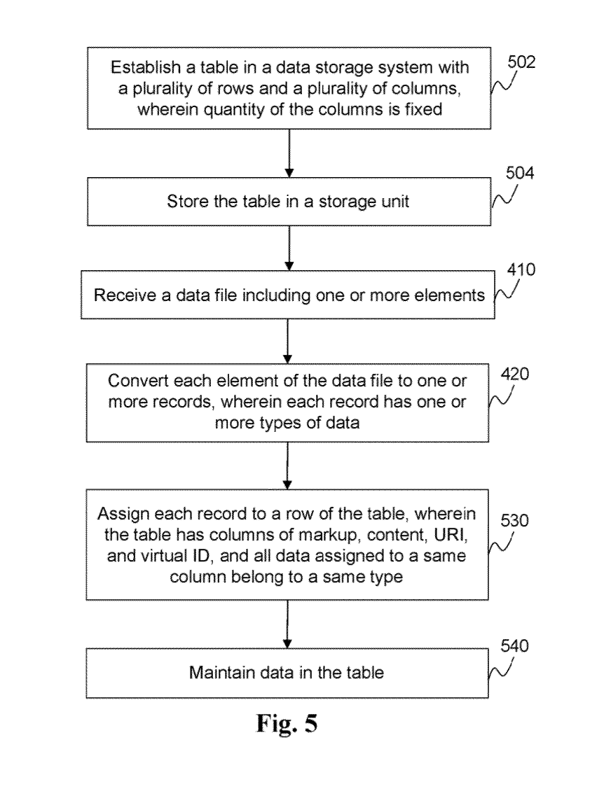

FIG. 5 is a flow chart illustrating another example of a method for maintaining data in a data storage system, according to an embodiment of the present disclosure. In accordance with various examples of the embodiment, the data storage system may be a database, a data warehouse, or a data file system. It will be described with reference to the above figures. However, any suitable unit may be employed. Beginning at block 502, a table is established in the data storage system with a plurality of rows and a plurality of columns. In one example, the quantity of the columns is fixed. As described above, block 502 may be performed by the establishing unit 202 in conjunction with the storage unit 210. Proceeding to block 504, the table is stored in a storage unit 210. At blocks 410 and 420, as described above, a data file including one or more elements is received, each element of the data file is converted to one or more records, and each record has one or more types of data. As described above, blocks 410 and 420 may be performed by the receiver 204 and the converting unit 206, respectively. Then at block 530, each record is assigned to a row of the table in the data storage system. In this example, the table has a plurality of rows and a plurality of columns comprising at least a markup column, a content column, a URI column, and a virtual ID column used to query data by identifying a collection of records. All data assigned to a same column belong to a same type. As described above, block 530 may be performed by the mapping unit 208 in conjunction with the storage unit 210. Moving to block 540, data in the table is maintained. As described above, block 540 may be performed by the processor 220 in conjunction with the storage unit 210. In this example, the data storage system may comprise a distributed data warehouse based on Hadoop or Hive and the data file may have an Extensible Markup Language (XML) format before being converted.

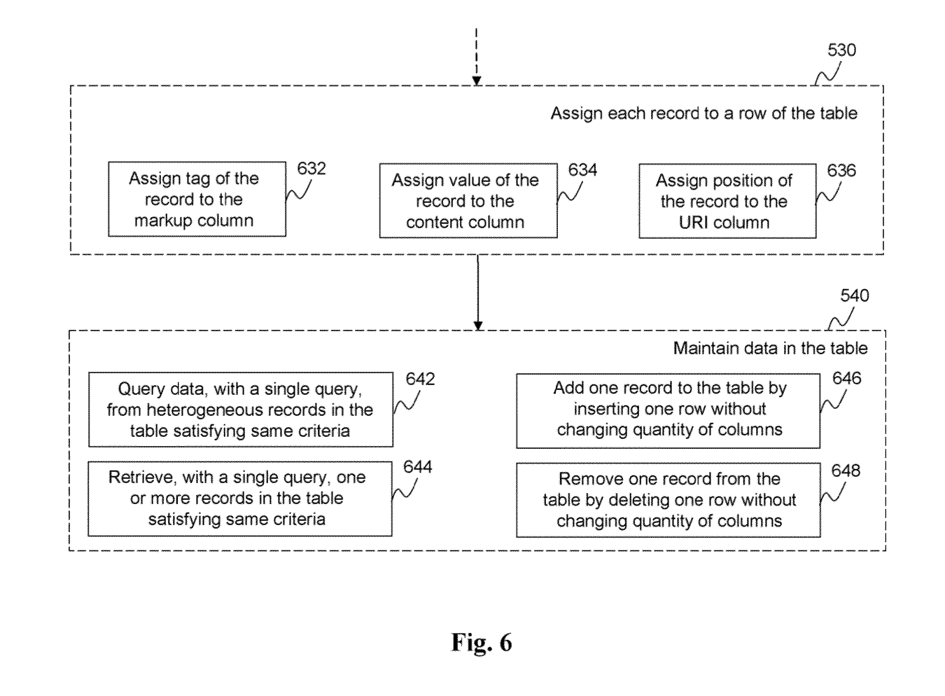

FIG. 6 is a flow chart illustrating an example of two steps in the method shown in FIG. 5, according to an embodiment of the present disclosure. It will be described with reference to the above figures. However, any suitable unit may be employed. At block 530, as described above, each record is assigned to a row of the table in the data storage system. In this example, each record has at least three types of data: tag, value, and position. And as shown in FIG. 6, the step of assigning each record in this example further comprises the steps shown in blocks 632, 634, and 636. At block 632, tag of the record is assigned to the markup column. At block 634, value of the record is assigned to the content column. And at block 636, position of the record is assigned to the URI column. As described above, blocks 632, 634, and 636 may be performed by the mapping unit 208 in conjunction with the storage unit 210.

Within block 540 shown in FIG. 6, the step of maintaining data in the table further comprises the steps shown in blocks 642, 644, 646, and 648. At block 642, data from heterogeneous records in the table satisfying same criteria is queried with a single query. As described above, block 642 may be performed by the querying unit 322 in conjunction with the storage unit 210. And at block 644, one or more records in the table satisfying same criteria is retrieved with a single query, based on their positions in the URI column. As described above, block 644 may be performed by the retrieving unit 326 in conjunction with the storage unit 210. Also, at block 646, one record is added to the table by inserting one row to the table without changing quantity of columns in the table. In addition, at block 648, one record is removed from the table by deleting one row from the table without changing quantity of columns in the table. As described above, blocks 646 and 648 may be performed by the modifying unit 324 in conjunction with the storage unit 210.

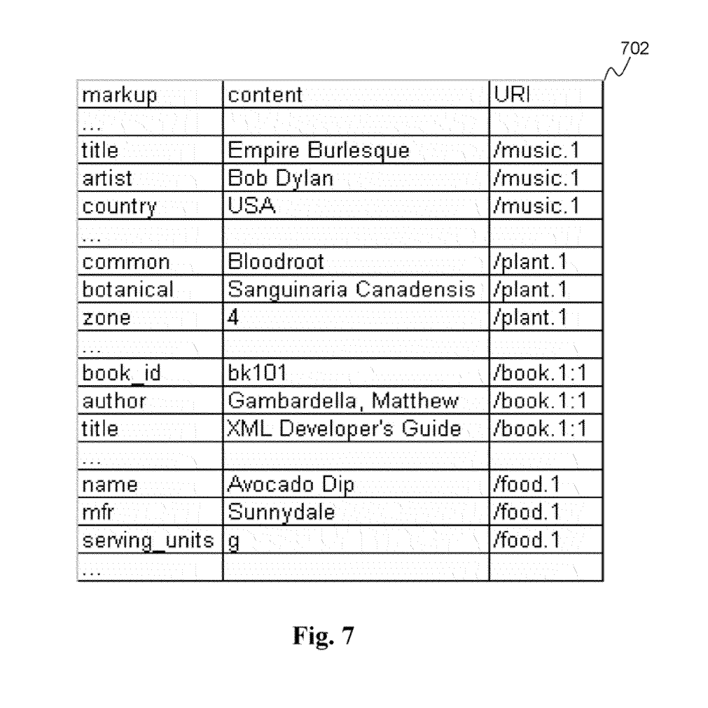

FIG. 7 shows a table illustrating an example of data placement, according to an embodiment of the present disclosure. In contrast to tables shown in FIG. 1, all purchase data for plant, music CD, book, and food in this example arc stored together in one single table 702. As shown in FIG. 7, the quantity of the columns in table 702 is fixed. In this example, tags of each record, e.g., “title” and “botanical”, are assigned to the markup column; values of each record corresponding to each tag, e.g., “Empire Burlesque” and “Sanguinaria Canadensis”, are assigned to the content column; and positions of each record, e.g., “/music.1” and “/plant.1”, are assigned to the URI column. With this column-based data placement, it is easy to query heterogeneous contents of the plant, music CD, book, and food data. For example, to count all records of plant, music CD, book, and food with prices greater than $9.99, instead of four separate queries, one Hive query suffices: “hive> select count(content) from my_table where markup=‘price’ and content>9.99”. The open schema's column-based data placement also simplifies the query task by flattening the data hierarchy with the help of the URI column's specific indication of data location. For example, one Hive query can get access to and retrieve all records that have unit_price=10.09.

The open schema approach illustrated in this example is easy to implement with its simple metadata, easy to maintain with its unified data model, and easy to get access to data with Hive's ad hoc query capability. The open schema approach does not require special binary large object (BLOB), or character large object (CLOB), or a Document Object Model (DOM) tree for data storage and traversal. The open schema approach does not require a special XML-enabled or homogeneous native XML, database for implementation. The open schema approach does not require complicated algorithms, special query engine or language like XQuery engines for data retrieval. XML data in different hierarchical structures may be processed with this single open schema. Data from different sources and in different formats, once converted, can be easily placed in a single data repository. The open schema provides not only an alternative to existing XML data storage solutions, but also a generic XML data model applicable to column-oriented data systems.

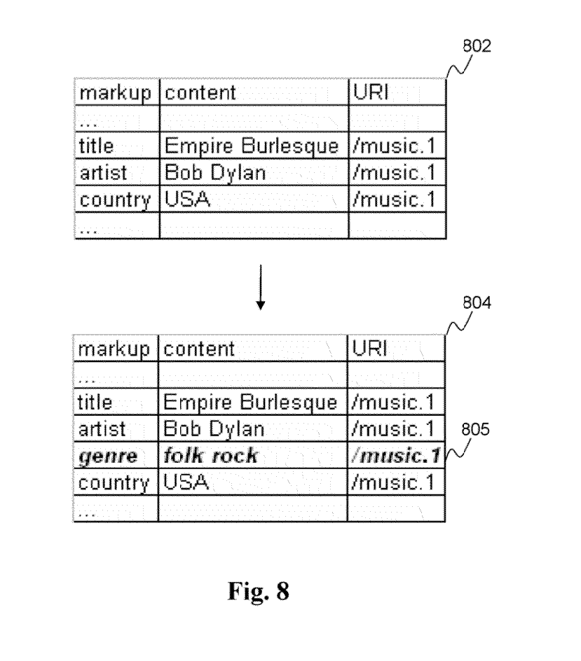

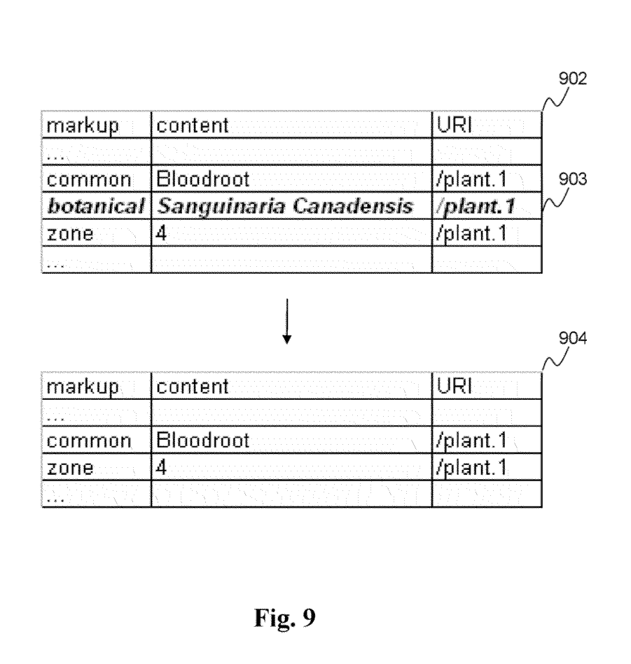

The open schema approach provides great data integrity as well as data scalability. With the open column-based data placement in this example, the data modifications previously mentioned in FIG. 1 happen only vertically, without any change of the data placement itself. The table structure is intact with the same number of columns. And there are just more or fewer rows after the modification, as in the examples shown in FIG. 8 and FIG. 9.

FIG. 8 shows tables illustrating an example of data modification, according to an embodiment of the present disclosure. To be specific, adding a “genre” field of music CD data to table 802 may be done by inserting one row 805 to the table 802 without changing quantity of columns in the table 802. The result after adding data is shown in table 804.

FIG. 9 shows tables illustrating another example of data modification, according to an embodiment of the present disclosure. To be specific, removing a “botanical” field of plant data from the table 902 may be done by deleting one row 903 from the table 902 without changing quantity of columns in the table 902. The result after removing data is shown in table 904.

To implement the present disclosure, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to maintain data essentially as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

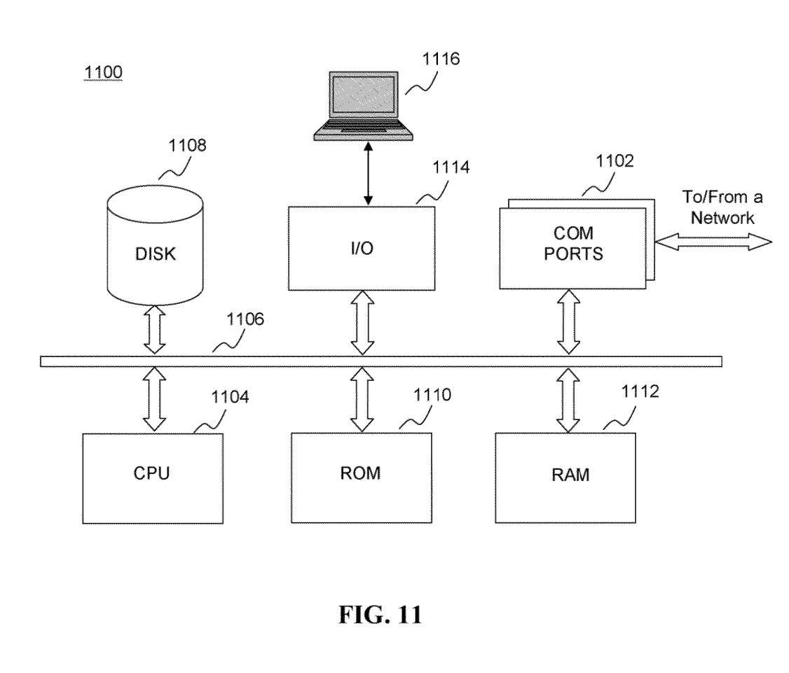

FIG. 11 depicts a general computer architecture on which the present disclosure can be implemented and has a functional block diagram illustration of a computer hardware platform that includes user interlace elements. The computer may be a general-purpose computer or a special purpose computer. This computer 1100 can be used to implement any components of the communication system as described herein. Different components of the data storage system 200, e.g., as depicted in FIG. 2, can all be implemented on one or more computers such as computer 1100, via its hardware, software program, firmware, or a combination thereof. Although only one such computer is shown, for convenience, the computer functions relating to connection establishment and communication may be implemented in a distributed fashion on a number of similar platforms, to distribute the processing load.

The computer 1100, for example, includes COM ports 1102 connected to and from a network connected thereto to facilitates data communications. The computer 1100 also includes a central processing unit (CPU) 1104, in the form of one or more processors, for executing program instructions. The exemplary computer platform includes an internal communication bus 1106, program storage and data storage of different forms, e.g., disk 1108, read only memory (ROM) 1110, or random access memory (RAM) 1112, for various data files to be processed and/or communicated by the computer, as well as possibly program instructions to be executed by the CPU. The computer 1100 also includes an I/O component 1114, supporting input/output flows between the computer and other components therein such as user interface elements 1116. The computer 1100 may also receive programming and data via network communications.

Hence, aspects of the method of maintaining data in a data storage system, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present disclosures are amenable to a variety of modifications and/or enhancements. For example, although the implementation of various components described above may be embodied in a hardware device, it can also be implemented as a software only solution—e.g., an installation on an existing server. In addition, the units of the host and the client nodes as disclosed, herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the disclosures may be applied in numerous applications, only some of which have been described herein. It is intended by the following claims to claim any and all applications, modifications and variations that fall within the true scope of the present disclosures.

We claim:

1. A method, implemented on at least one machine having at least one processor, storage, and a communication platform connected to a network for maintaining data in a data storage system, comprising the steps of:
receiving a data file including one or more elements;
converting each element of the data file to one or more records, wherein each record has one or more types of data;
assigning each record to a row of a table in the data storage system, wherein:
the table has a plurality of rows and a plurality of columns comprising at least a markup column, a content column, and a uniform resource identifier (URI) column, and
all data assigned to a same column belong to a same type; and
maintaining data in the table.

2. The method of claim 1, wherein:
each record has at least three types of data tag, value, and position; and
the step of assigning each record further comprises:
assigning tag of the record to the markup column,
assigning value of the record to the content column, and
assigning position of the record to the URI column.

3. The method of claim 1, wherein the table further comprises a virtual column identification (ID) used to query data by identifying a collection of records.

4. The method of claim 1, wherein the step of maintaining data in the table further comprises querying data, with a single query, from heterogeneous records in the table satisfying same criteria.

5. The method of claim 1, wherein the step of maintaining data in the table further comprises:
adding one record to the table by inserting one row to the table without changing quantity of columns in the table; and
removing one record from the table by deleting one row from the table without changing quantity of columns in the table.

6. The method of claim 1, wherein the step of maintaining data in the table further comprises retrieving, with a single query, one or more records in the table satisfying same criteria based on their positions in the URI column.

7. The method of claim 1, further comprising the steps of:
establishing the table in the data storage system with a plurality of rows and a plurality of columns, wherein quantity of the columns is fixed; and
storing the table in a storage unit.

8. The method of claim 1, wherein:
the data storage system comprises a distributed data warehouse based on Hadoop or Hive; and
the data file has an Extensible Markup Language (XML) format before being converted.

9. A system for maintaining data in as data storage system, comprising:
a receiver configured to receive a data file including one or more elements;
a converting unit coupled to the receiver and configured to convert each element of the data file to one or more records, wherein each record has one or more types of data;
a mapping unit coupled to the converting unit and configured to assign each record to a row of a table in the data storage system, wherein:
the table has a plurality of rows and a plurality of columns comprising at least a markup column, a content column, and a URI column, and
all data assigned to a same column belong to a same type; and
a processor configured to maintain data in the table.

10. The system of claim 9, wherein:
each record has at least three types of data: tag, value, and position; and
for each record, the mapping unit is further configured to:
assign tag of the record to the markup column,
assign value of the record to the content column, and
assign position of the record to the URI column.

11. The system of claim 9, wherein the table further comprises a virtual column ID used to query data by identifying a collection of records.

12. The system of claim 9, wherein the processor further comprises a querying unit configured to query data, with a single query, from heterogeneous records in the table satisfying same criteria.

13. The system of claim 9, wherein the processor further comprises a modifying unit configured to:
add one record to the table by inserting one row to the table without changing quantity of columns in the table; and
remove one record from the table by deleting one row from the table without changing quantity of columns in the table.

14. The system of claim 9, wherein the processor further comprises a retrieving unit configured to retrieve, with a single query, one or more records in the table satisfying same criteria based on their positions in the URI column.

15. The system of claim 9, further comprising:
an establishing unit configured to establish the table in the data storage system with a plurality of rows and a plurality of columns, wherein quantity of the columns is fixed; and
a storage unit coupled to the establishing unit, the mapping unit, and the processor, and configured to store the table.

16. The system of claim 9, wherein:
the data storage system comprises a distributed data warehouse based on Hadoop or Hive; and
the data file has an XML format before being converted.

17. A machine-readable tangible and non-transitory medium having information for maintaining data in a data storage system, wherein the information, when read by the machine, causes the machine to perform the following steps:
receiving a data file including one or more elements;
converting each element of the data file to one or more records, wherein each record has one or more types of data;
assigning each record to a row of a table in the data storage system, wherein:
the table has a plurality of rows and a plurality of columns comprising at least a markup column, a content column, and a URI column, and
all data assigned to a same column belong to a same type; and
maintaining data in the table.

18. The medium of claim 17, wherein:
each record has at least three types of data: tag, value, and position; and
the step of assigning each record further comprises:
assigning tag of the record to the markup column,
assigning value of the record to the content column, and
assigning position of the record to the URI column.

19. The medium of claim 17, wherein the table further comprises a virtual column ID used to query data by identifying a collection of records.

20. A method, implemented on at least one machine having at least one processor, storage, and a communication platform connected to a network for storing data in a data storage system, comprising the steps of:
receiving a data record in a first format;
converting the data record in the first format into one or more converted data records in a second format, wherein each of the one or more converted data records comprises a markup attribute, a content attribute, and an identifier attribute used to locate the data record in the first format; and
storing the one or more converted data records in the data storage system.

21. A method, implemented on at least one machine having at least one processor, storage, and a communication platform connected to a network for generating data, comprising the steps of:
receiving a piece of information comprising one or more parts;
identifying the one or more parts of the piece of information; and
generating one or more data records, each for a part of the piece of information, wherein each of the one or more data records comprises a markup attribute, a content attribute, and an identifier attribute used to locate the corresponding part in the piece of information.
